(19) United States
(12) Patent Application Publication
(10) Pub. No.: US 2023/0327999 A1
(43) Pub. Date: Oct. 12, 2023

(54) NODE AND METHODS PERFORMED THEREBY FOR HANDLING ONE OR MORE MEMBER STREAMS

(71) Applicant: Telefonaktiebolaget LM Ericsson (publ), Stockholm (SE)

(72) Inventors: Balázs VARGA, Budapest (HU); János FARKAS, Kecskemét (HU); György MIKLÓS, Pilisborosjenö (HU)

(21) Appl. No.: 18/044,102

(22) PCT Filed: Sep. 16, 2020
(86) PCT No.: PCT/SE2020/050864

§ 371 Date: Mar. 6, 2023

(51) Int. Cl. H04L 47/28; H04L 1/08

(52) U.S. Cl. CPC H04L 47/28; H04L 1/08

(57) ABSTRACT

A method performed by a node, for handling one or more member streams split from a stream of frames. The node supports at least replication function and one elimination function, to process the one or more member streams. The node operates in a communications network. The node assigns an indication to a frame of one or more frames comprised in a first member stream outgoing from the at least one elimination function. The indication is the same in every frame of the one or more frames. The indication identifies the first member stream as an output member stream in the stream. The node forwards the first member stream outgoing from the at least one elimination function, identified by the indication, to another function supported by the node, or to another node.

### TECHNICAL FIELD

The present disclosure relates generally to a node and methods performed thereby for handling one or more member streams. The present disclosure further also relates generally to computer programs and computer-readable storage mediums, having stored thereon the computer programs to carry out these methods.

### BACKGROUND

Computer systems in a communications network may comprise one or more nodes. A node may comprise one or more processors which, together with computer program code may perform different functions and actions, a memory, a receiving and a sending port. A node may be, for example, a bridge.

Standard Information Technology infrastructure may not be able to handle extreme latency-sensitive data with a required level of efficiency. Switches and routers may process packets and/or frames in such a way that data flow may be sporadic. Deterministic Networking (DetNet) is an effort by the IETF DetNet Working Group to study providing support for real-time applications by implementing reservation of data plane resources in intermediate nodes along a data path, calculation of explicit routes which may be independent, and redistribution of data packets over time and/or space to deliver data even with the loss of one path. Deterministic data paths may be understood to aim to support real-time applications, such as audio and video streaming, industrial automation, and vehicle control, by guaranteeing extremely low data loss rates, packet delay variation (jitter), and bounded latency.

Time Sensitive Networking (TSN) is currently being developed at the IEEE as a new technology that may enhance the IEEE 802.1 and IEEE 802.3 Ethernet standard to an entirely new level of determinism. It may be considered as an evolution of Ethernet to guarantee low end-to-end latency, low jitter and low packet loss.

The Time-Sensitive Networking (TSN) Task Group (TG) within IEEE 802.1 WG deals with Deterministic services through IEEE 802 networks. The TSN TG specifies the tools of the TSN toolbox, as well as the use of the tools for a particular purpose. TSN TG is chartered to provide deterministic services through IEEE 802 networks with guaranteed packet transport, low packet loss, bounded low latency, and low packet delay variation.

In order to achieve extreme low packet loss, TSN TG specified Frame Replication and Elimination for Reliability (FRER), e.g., in IEEE 802.1CB-2017. FRER may be understood to be targeted to avoid frame loss due to equipment failure. It may be understood, practically, as a per-frame 1+1 (or 1+n) redundancy function. Instead of relying on failure detection and/or switchover incorporated, FRER may rely on dividing a stream into one or more linked member streams, thus making the original stream a compound stream. FRER may replicate the frames, which may be referred to as packets in the specification, of the stream via a so-called Replication function, splitting the copies into the multiple member streams, and may then rejoin those member streams at one or more other points, eliminating the replicates via a so-called Elimination function, and may then deliver the reconstituted stream from those points. In other words, FRER may be understood to send frames on two, or more, maximally disjoint paths by replicating the frames via the so-called Replication function, then combine the streams and delete extra frames via the so-called Elimination function, which functions may be as described in 802.1CB IEEE standard.

Replication and Elimination functions and their enhancements may therefore be understood to provide redundancy support. Redundancy support is also standardized for radio links/5G systems, as e.g., in 3GPP TS 23.501 v.16.5.1, section 5.33.2.1, that may be integrated into TSN networks, e.g., for industrial verticals.

In spite of the advancements provided by FRER, the functionality supported in single nodes is limited, which may place demands on the numbers of nodes that may be required to support certain processing of streams, resulting in highly complex network topologies. Complex network topologies may lead to additional errors, and delays in the processing of the streams.

### SUMMARY

Depending on network topology and the node and/or link characteristics, there may be multiple nodes in a TSN network, where network design may require the implementation of replication (R) and/or elimination (E) function(s). The number of FRER functions, R or E, which may be needed on a node for a given TSN stream may be referred to herein as the “number of FRER stages” on that node. For example, a node configured for only a single R or E function may be referred as a “single FRER stage node”. A node configured for an E function followed by an R function may be referred as a “two FRER stage node”, and so on. FIG. 1 is a schematic diagram depicting six different nodes with FRER stages, wherein each node depicted in panel a), b), c), d), e) and f), respectively. The arrows depict the participating member streams. The nodes depicted in panels a) and b) have a single FRER stage, R in a), and E in b). The nodes depicted in panels c) and d) have double FRER stages: E and R in c) and R and E in d). The nodes depicted in panels e) and f) have triple FRER stages: E, R and E in e) and R, E and R in f).

It may be understood that other combinations than those represented in FIG. 1 may be possible. From an external node perspective, stages with the same types may be collapsed, e.g., R+R=R, E+E+R=E+R.

It may be also appreciated that multi stage FRER may make sense when member streams may be non-risk-sharing. As a general design rule, a FRER function may be understood to have to never receive back its own already processed packets from a FRER function of another node. In other words, the FRER graph describing the FRER functions along the path of a stream may be understood to need to be loop free.

FIG. 2 is a schematic diagram depicting an example of a FRER graph, showing a TSN stream over a given network topology with the designed FRER functions, as represented with the R and E points.

Member streams may be defined between FRER functions (E or R). The locations of FRER functions may be in different nodes, then the member stream may be visible on the wire between the nodes. The locations of FRER functions may be in the same node, and in such case the member streams may not be externally visible. In case of a packet on the wire, the encapsulation, e.g., Ethernet header fields, may be used to identify a member stream.

The current specification does not support multiple FRER stage nodes.

In order to be multi FRER stage capable, a node may be understood to need to allow daisy chaining of R and/or E functions. This may be understood to mean that some of the member streams of a stream of frames may become internal on the node, so implementation of FRER functions may be understood to need to be able to work with internal member streams as well. Furthermore, it may be understood to need to be also required that R and E functions may be able to set the parameters of their output frames, as they may be an input member stream for the next FRER stage. A non-limiting example of such a parameter may be understood to be a stream_handle parameter. Such a parameter may be understood to identify the stream to which the packet may belong during the processing within the node, and to refer to its encapsulation. In case of a frame within a node, metadata traveling with the frame across the node internal functions may be used to identify the member stream to which it may belong. This metadata may have local significance. Each member stream processed on a node may have its own metadata value, which may be unique on the node. For ingress member streams, the node may fill this metadata based on the encapsulation of the received packet. An example of such metadata may be, e.g., a stream_handle parameter.

For the replication (R) function, setting the stream_handle parameters of the resulting member streams may be as defined in IEEE 802.1CB-2017, section 7.7 Stream splitting function; “ . . . makes zero or more copies of that packet, each with a stream_handle subparameter that can be different from the original stream_handle . . . ”. IEEE 802.1CB-2017 also defines the related management objects, in section 10.6.1.3 frerSplitInputIdList and section 10.6.1.4 frerSplitOutputIdList. Note that “packet” in the IEEE 802.1CB-2017 specification may be understood to refer to “frame” as used herein.

However, for the elimination (E) function, setting the stream_handle parameters of the resulting TSN Stream is not defined in IEEE 802.1CB-2017, only the input member streams related management objects are defined in the section “10.4.1.1 frerSeqRcvyStreamList” parameter.

According to the foregoing, for the implementation of a multi FRER stage node, a new functionality may be necessary, that may be capable to set the stream_handle parameter of the outgoing frames of an elimination (E) function.

It is an object of embodiments herein to improve the handling of one or more member streams split from a stream of frames within a communications network. It is a particular object of embodiments herein to improve the handling of one or more member streams split from a stream of frames within a communications network by introducing a new functionality to support multi-stage FRER in nodes of the communications network.

According to a first aspect of embodiments herein, the object is achieved by a method performed by a node. The method is for handling one or more member streams split from a stream of frames. The node supports at least one replication function and at least one elimination function, and to process the one or more member streams. The node operates in a communications network. The node assigns an indication to a frame of one or more frames comprised in a first member stream of the one or more member streams, the first member stream outgoing from the at least one elimination function. The indication is the same in every frame of the one or more frames. The indication identifies the first member stream as being an output member stream comprised in the stream of frames. The node also forwards the first member stream outgoing from the at least one elimination function, comprising the one or more frames as identified by the indication, to at least one of: a) another function supported by the node, and b) another node operating in the communications network.

According to a second aspect of embodiments herein, the object is achieved by a node, for handling the one or more member streams configured to be split from the stream of frames. The node is configured to support at least one replication function and at least one elimination function, and to process the one or more member streams. The node is further configured to operate in the communications network. The node is also configured to, assign the indication to the frame of the one or more frames configured to be comprised in the first member stream of the one or more member streams, the first member stream being configured to be output from the at least one elimination function. The indication is configured to identify the first member stream as being an output member stream comprised in the stream of frames. The node is further configured to forward the first member stream configured to be output from the at least one elimination function, comprising the one or more frames as configured to be identified by the indication, to at least one of: a) the another function supported by the node, and b) the another node configured to operate in the communications network.

According to a third aspect of embodiments herein, the object is achieved by a computer program, comprising instructions which, when executed on at least one processor, cause the at least one processor to carry out the method performed by the node.

According to a fourth aspect of embodiments herein, the object is achieved by a computer-readable storage medium, having stored thereon the computer program, comprising instructions which, when executed on at least one processor, cause the at least one processor to carry out the method performed by the node.

By the indication identifying the first member stream as being an output member stream comprised in the stream of frames, and then the node assigning the indication to the frame of one or more frames comprised in the first member stream outgoing from the at least one elimination function, the node may then be enabled to support multi-stage functionality comprising the at least one elimination function, so that the first member stream outgoing from the at least one elimination function may be forwarded appropriately. By the node then forwarding the first member stream output from the at least one elimination function, as identified by the indication, the node may then be enabled to support multi-stage functionality comprising the at least one elimination function so that the first member stream output from the at least one elimination function may be enabled to be received appropriately, with a well-defined identifier by the another function, namely, the next internal function within the node, or with proper encapsulation to be recognized by the another node operating in the communications network, e.g., the next-hop node. For examples wherein the first member stream may be an egress member stream, by the indication being the same in every frame of the one or more frames, the encapsulation may be simplified, for example even in cases wherein the frames of the first member stream may have originated in different member streams.

### BRIEF DESCRIPTION OF THE DRAWINGS

Examples of embodiments herein are described in more detail with reference to the accompanying drawings, according to the following description.

FIG. 1 is a schematic diagram illustrating different examples, each in panel a)-f), of nodes with FRER stages, according to existing methods.

FIG. 2 is a schematic diagram illustrating an example of a TSN stream with different FRER functions, according to existing methods.

FIG. 3 is a schematic diagram illustrating a non-limiting example of a communications network, according to embodiments herein.

FIG. 4 is a flowchart depicting embodiments of a method in a node, according to embodiments herein.

FIG. 5 is a schematic diagram illustrating an example of values of “stream_handle” in a multi stage FRER node, according to embodiments herein.

FIG. 6 is a schematic block diagram illustrating two non-limiting examples, a) and b), of a node, according to embodiments herein.

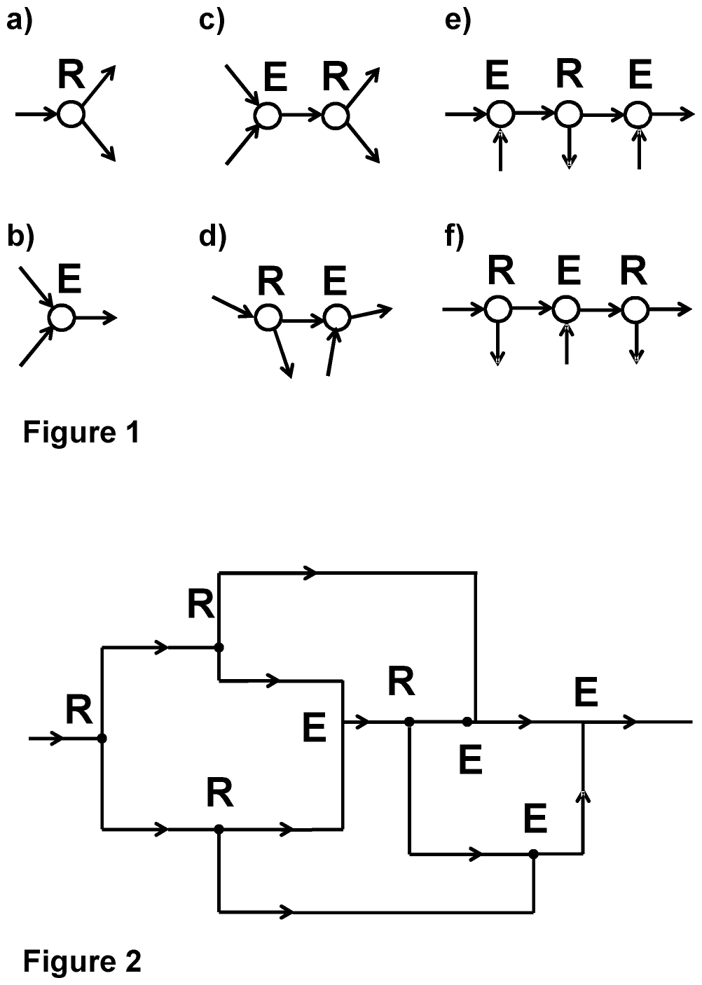

### DETAILED DESCRIPTION

As part of the development of embodiments herein, a number of problems with exiting methods will first be identified and discussed.

As explained in the Summary section herein, for the implementation of a node supporting more than a single replication (R) or elimination (E) functionality, e.g., for the implementation of a multi-stage FRER node, there may be understood to be a need for a new functionality, that may be capable to set one or more parameters, e.g., the stream_handle parameter, of the outgoing frames of an E function. This new functionality may be understood to be needed for instances of a sequence recovery function, as e.g., described in section 7.4.2 of IEEE 802.1CB-2017. This may be understood to be in contrast with an individual recovery function, such as that described in section 7.5 of IEEE 802.1CB-2017, which may be understood to not require such new functionality as it may be understood to work on a single member stream, wherein the outgoing frames may be understood to have a same stream_handle parameter.

Nodes supporting a single E function may be understood to output encapsulated member streams that cannot be processed by internal functions. Furthermore, the E function in a node supporting the single E function may copy the metadata from the frames it may output from the source frames in the member streams they may originate from. For cases wherein the resulting egress member may comprise frames from different origin, the encapsulation of such an egress member may need to have metadata from both member streams, increasing its size and complexity.

Several embodiments are comprised herein, which address these problems of the existing methods. Embodiments herein may be, from a general perspective, understood to relate to supporting multi-stage FRER in a TSN. Embodiments herein address how multi-stage FRER functionality may be achieved within a single node and provide the extensions that may need to be added to the relevant standards. Further particularly, embodiments herein may be understood to provide an improvement of the Replication and Elimination function as described in IEEE 802.1CB-2017.

The embodiments disclosed herein, may be understood to introduce a new FRER functionality to set the stream_handle parameter of the outgoing frames of an elimination (E) function in order to be able to support multi-stage FRER. This new functionality may be added to the instances of sequence recovery function, as e.g., described in Section 7.4.2 of IEEE 802.1CB-2017. The embodiments disclosed herein may also define a new parameter, e.g., a new managed object, related to the new functionality, namely “frerSeqRcvyStreamOut”.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments.

Although terminology and variable names where appropriate from the IEEE 802.1CB has been used in this disclosure to exemplify the embodiments herein, e.g., denoted as “VariableName”, this should not be seen as limiting the scope of the embodiments herein to only the aforementioned system. New variables, functions and parameters may follow the IEEE 802.1CB naming convention and may be denoted as “NewEntityName”.

Other systems supporting similar or equivalent functionality may also benefit from exploiting the ideas covered within this disclosure. In future network access, the terms used herein may need to be reinterpreted in view of possible terminology changes in future radio access technologies.

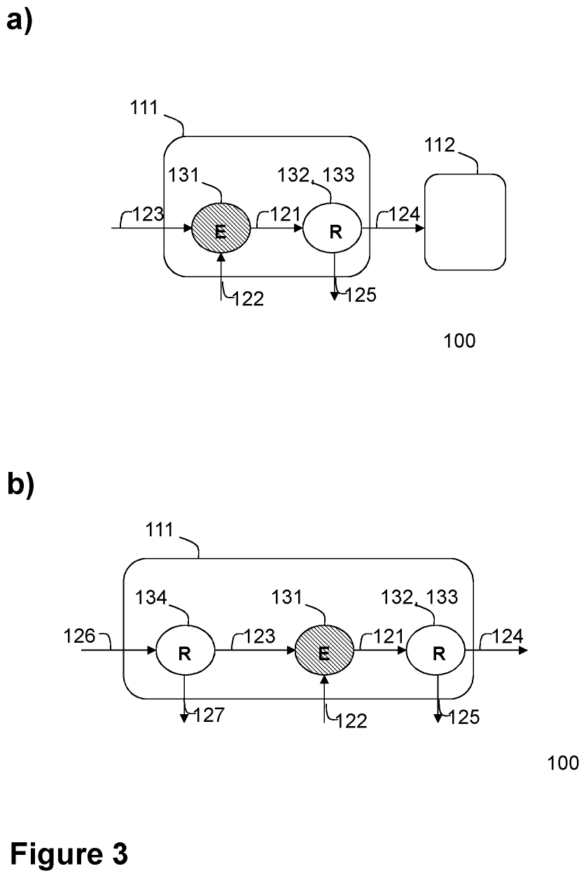

FIG. 3 is a schematic diagram depicting two non-limiting examples, in panels a) and b), respectively, of a communications network 100, in which embodiments herein may be implemented. The communications network 100 may be understood as a computer network, as depicted in in the non-limiting example of FIG. 3. The communications network 100 may be an Ethernet network providing transport for Layer-2 streams, or a network with similar functionality. In some embodiments, the communications network 100 may be a deterministic network, e.g., a DetNet. In particular embodiments, the communications network 100 may support Time Sensitive Networking (TSN). In some example implementations, the communications network 100 may be implemented in a telecommunications network, sometimes also referred to as a cellular radio system, cellular network or wireless communications system. In some examples, the telecommunications network may comprise network nodes which may serve receiving nodes, such as wireless devices, with serving beams. In some examples, the telecommunications network may for example be a network such as a 5G system, a 5G Network, or a Next Gen network. The telecommunications network may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

The communications network 100 comprises nodes, whereof a first node, also referred to herein simply as a node 111 is depicted in the non-limiting examples of FIG. 3. The communications network 100 may, in some embodiments such as that the example depicted in panel b) of FIG. 3, comprise another node 112, which may be referred to herein as a second node. It may be understood that more nodes may be comprised in the communications network 100, and that the number of nodes depicted in FIG. 3 is for illustration purposes only. Each of the node 111 and the another node 112 may be understood, respectively, as a first computer system and a second computer system. In particular, any of the node 111 and the another node 112 may be a transport node, such as e.g., a Layer-2 transport node or a bridge, that is, a networking device that may be enabled to forward a stream of frames between nodes, that is between a source entity and a destination entity, e.g., in a pipeline. Any of the node 111 and the another node 112 may be under the ownership or control of a service provider, or may be operated by the service provider or on behalf of the service provider. Any of the node 111 and the another node 112 may be implemented, in as a standalone server in e.g., a host computer in the cloud. Any of the first node 111 and the another node 112 may be comprised in a radio network node, e.g., a gNB, in a Radio Access Network (RAN) of the telecommunications network, or in a core network of the telecommunications network.

The node 111 may process one or more member streams 121, 122, 123, 124, 125, 126, 127 of a compound stream of frames that may be routed via the node 111 from a source entity to a destination entity, via different functions. A stream may be understood herein as a unidirectional flow of data, e.g., time-sensitive data from one source entity to one or more destination entities, and at the highest level, from one Talker end system to one or more Listener end systems. A compound stream may be understood herein as a stream composed of one or more member streams linked together via frame Replication and Elimination for Reliability (FRER). A member stream may be understood herein as a stream that may be linked with other member streams via Frame Replication and Elimination for Reliability (FRER) to form a compound stream.

In FIG. 3, each of the member streams 121, 122, 123 124, 125, 126, 127 is depicted by an arrow, representing the direction of the member stream. The node 111 supports at least one elimination function (E) 131 and another function 132. Which member stream 121, 122, 123 124, 125, 126, 127 may be processed by each function may be understood to be based on design, e.g., based on the order of the functions. The node 111 also supports at least one replication function (R) 133 to process the member streams 121, 123, 124, 125, 126, 127 of the stream of frames routed via the node 111 from a source entity to a destination entity. The non-limiting example of FIG. 3 a), depicts the node 111 comprising one elimination function 131, depicted with a striped circle, and one replication function 133, depicted by a solid white circle. In the simplest scenarios, wherein the node 111 has two functions, such as that depicted in panel a) of FIG. 3, the another function 132 may be the at least one replication function 133. Yet in other scenarios wherein the node 111 may comprise more functions, the another function 132 may be the same as the at least one replication function 133, as depicted in the example of panel b) of FIG. 3, or may not be the same function, which is not depicted. The non-limiting example of FIG. 3 b), depicts the node 111 comprising one elimination function 131, depicted with a striped circle, a first replication function 133 and a second replication function 134, each depicted by a solid white circle. It may be noted that examples depicted in FIG. 3 are non-limiting. The elimination function 131 may be a first stage of the node 111, as depicted in panel a), or a last stage of the node 111, which is not depicted.

Of the one or more member streams 121, 122, 123, 124, 125, 126, 127, a first member stream 121 may be output from the at least one elimination function 131.

The node 111 may be configured to communicate within the communications network 100 with the another node 112 over a link or connection, which may be a wired link, a radio link, an infrared link, etc . . . The connection may be understood to be able to be comprised of a plurality of individual links. The connection may be a direct link or it may go via one or more computer systems or one or more core networks in the communications network 100, which are not depicted in FIG. 3, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 3.

In general, the usage of “first” and/or “second” herein may be understood to be an arbitrary way to denote different elements or entities, and may be understood to not confer a cumulative or chronological character to the nouns they modify.

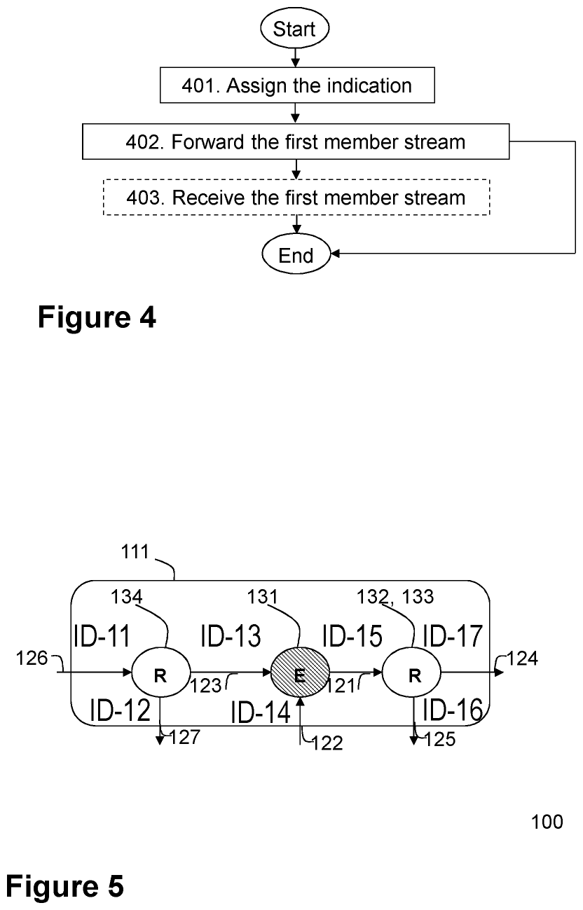

Embodiments of a method performed by the node 111, will now be described with reference to the flowchart depicted in FIG. 4. The method may be understood to be for handling one or more member streams 121, 122, 123 split from a stream of frames. As stated earlier, the node 111 supports at least one replication function 133 and at least one elimination function 131 to process the one or more member streams 121,122, 123. The node 111 operates in the communications network 100.

In particular embodiments, the node 111 may support multi-stage FRER.

The method may comprise the actions described below. Several embodiments are comprised herein. In some embodiments all the actions may be performed. In some embodiments some of the actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, an optional action is indicated with dashed boxes.

Action 401

In the course of operations of the communications network 100, a stream of frames, or at least a part of a stream of frames, may go through the node 111 en route from a source entity or talker, to a destination entity or listener. The stream of frames my arrive at the node 111 as a single stream or as one, or more, member streams of the stream of frames. The frames may be understood to comprise a plurality of packets. Different streams, or member streams, may comprise different number of frames. The node 111 may then further process the stream, member stream or member streams of the stream of frames, in order to route the stream of frames from the source entity to the destination entity. The node 111 may be understood to process the stream, member stream or member streams of the stream of frames via the at least one elimination function 131, and the at least one replication function 133. The at least one elimination function 131 may be understood to eliminate one ingress, or input, member stream, whereas the at least one replication function 133 may be understood to replicate an ingress, or input, member stream into two egress, or output, member streams.

In this Action 401, the node 111 assigns an indication to a frame of one or more frames comprised in the first member stream 121, of the one or more member streams 121, 122, 123, the first member stream 121 outgoing from the at least one elimination function 131. The indication is the same in every frame of the one or more frames. The indication identifies the first member stream 121 as being an output member stream comprised in the stream of frames.

The assigning in this Action 401 of the indication may be performed to every frame of the one or more frames comprised in the first member stream 121.

The indication may uniquely identify the one or more frames comprised in the first member stream 121 from any frames comprised in the other one or more member streams 122, 123 of the node 111.

In some embodiments, the first member stream 121 may comprise at least two frames originated in different input or ingress member streams or different member streams input into the at least one elimination function 131.

The assigning in this Action 401 may comprise, e.g., changing a parameter to handle the stream to the indication.

The parameter may be, in some embodiments, a stream_handle parameter.

The indication may be a managed object. In particular embodiments, the indication, which may be understood to be a new parameter, may be referred to as “frerSeqRcvyStreamOut”. frerSeqRcvyStreamOut may be defined as a new stream_handle parameter to be used for the output packet of the at least one elimination function 131.

In some embodiments, the assigning in this Action 401 may be performed prior to a PRESENT_DATA event in a Sequence Recovery Function that may be run by the node 111.

In other embodiments, the assigning in this Action 401 may be performed during an Individual Recovery Function . Yet in other examples, the node 111 may refrain from performing the assigning in this Action 401 when a recovery function performed may be an Individual Recovery Function.

By the indication identifying the frame of the one or more frames comprised in the first member stream 121 as being an output member stream comprised in the stream of frames, and then the node 111 assigning the indication to the first member stream 121 outgoing, e.g., egressing, from the at least one elimination function 131, the node 111 may then be enabled to support multi-stage functionality comprising the at least one elimination function 131, so that the first member stream 121 outgoing from the at least one elimination function 131 may be forwarded appropriately and with a well-defined identifier. For examples wherein the first member stream may be an egress member stream, by the indication being the same in every frame of the one or more frames, the encapsulation may be simplified, for example even in cases wherein the frames of the first member stream may have originated in different member streams.

Action 402

In this Action 402, the node 111 forwards the first member stream 121 output from the at least one elimination function 131, comprising the one or more frame identified by the indication, to at least one of: a) the another function 132 supported by the node 111, that is the next function within the node 111, or the next stage within the node 111, and b) the another node 112 operating in the communications network 100, e.g., a next-hop node, in the event that the at least one elimination function 131 may be the last function, or last stage, within the node 111.

By the node 111 forwarding the first member stream 121 output from the at least one elimination function 131, comprising the one or more frames identified by the indication, the node 111 may then be enabled to support multi-stage functionality comprising the at least one elimination function so that the first member stream 121 output from the at least one elimination function 131 may be enabled to be received appropriately and with a well-defined identifier by the another function 132, namely, the next internal function within the node 111, or by the another node 112 operating in the communications network 100.

Action 403

In some embodiments wherein in Action 402, the node 111 may have forwarded the first member stream 121 to the another function 132, that is, internally, in this Action 403, the node 111 may receive, at the another function 132, the first member stream 121 output from the at least one elimination function 131, comprising the one or more frames identified by the indication.

An advantage provided by this Action 403 is that the node 111 may then be enabled to support multi-stage functionality comprising the at least one elimination function so that the first member stream 121 output from the at least one elimination function 131 may be received appropriately and with a well-defined identifier by the another function 132.

FIG. 5 is a schematic diagram depicting a non-limiting example for a multi-stage FRER scenario of embodiments herein, wherein the node 111 comprises the at least one elimination function 131 the at least one replication function 133 and the second replication function 134. FIG. 5 shows the stream_handles handled by the node 111 in such a scenario. As depicted, there are two ingress member streams (ID-11, ID-14) and three egress member streams (ID-12, ID-16, ID-17). Member streams with ID-13 and ID-15 are internal member streams, so they are not visible outside of the node 111. According to embodiments herein, the at least one elimination function 131 assigns the indication, in this example “ID-15”, to the first member stream 121, to allow that the frames, which as mentioned earlier may be referred to as packets in FRER, of the outgoing internal member stream have ID-15 as stream_handle parameter after the sequence recovery function on member streams ID-13 and ID-14 has been executed.

Regarding implementation, the new functionality described in embodiments herein may be added by extending the VectorRecoveryAlgorithm, as e.g., described in section 7.4.3.4 of IEEE 802.1CB-201, and the MatchRecoveryAlgorithm, as e.g., described in section 7.4.3.5 of IEEE 802.1CB-2017. The extension may be understood to be to change the stream_handle parameter of the processed packet before the PRESENT_DATA event, when the algorithms may be used for a sequence recovery function, as shown below in a non-limiting example:

if (frerSeqRcvyIndividualRecovery = False) {
stream_handle = frerSeqRcvyStreamOut
}
PRESENT_DATA

The modification according to embodiments herein may be understood to need to be added at each point in the algorithms code, where “PRESENT_DATA” may appear in “void VectorRecoveryAlgorithm ( )” and “void MatchRecoveryAlgorithm ( )”.

As a summarized overview of the foregoing, embodiments herein may be understood to address that for the implementation of a multi-stage FRER node such as the node 111, there may be understood to be a need for a new functionality, that may be capable to set the stream_handle parameter of the outgoing frames of an elimination (E) function. This new functionality may be needed for instances of sequence recovery function, as for example described in section 7.4.2 of IEEE 802.1CB-2017. According to embodiments herein, a new parameter, e.g., a managed object, may be defined, which may be related to the new functionality, namely “frerSeqRcvyStreamOut”. According to embodiments herein, describe how the new functionality may be added by modifying the VectorRecoveryAlgorithm and the MatchRecoveryAlgorithm.

One advantage of embodiments herein is that, by the node 111 assigning the indication, and then forwarding the first member stream 121 outgoing from the at least one elimination function 131 identified by the indication, embodiments herein allow the implementation of multi-stage FRER functions for TSN nodes, which may be understood to be a requirement in complex TSN network topologies, including TSN networks comprising radio links.

Another advantage of embodiments herein is their easy addition to existing FRER implementations.

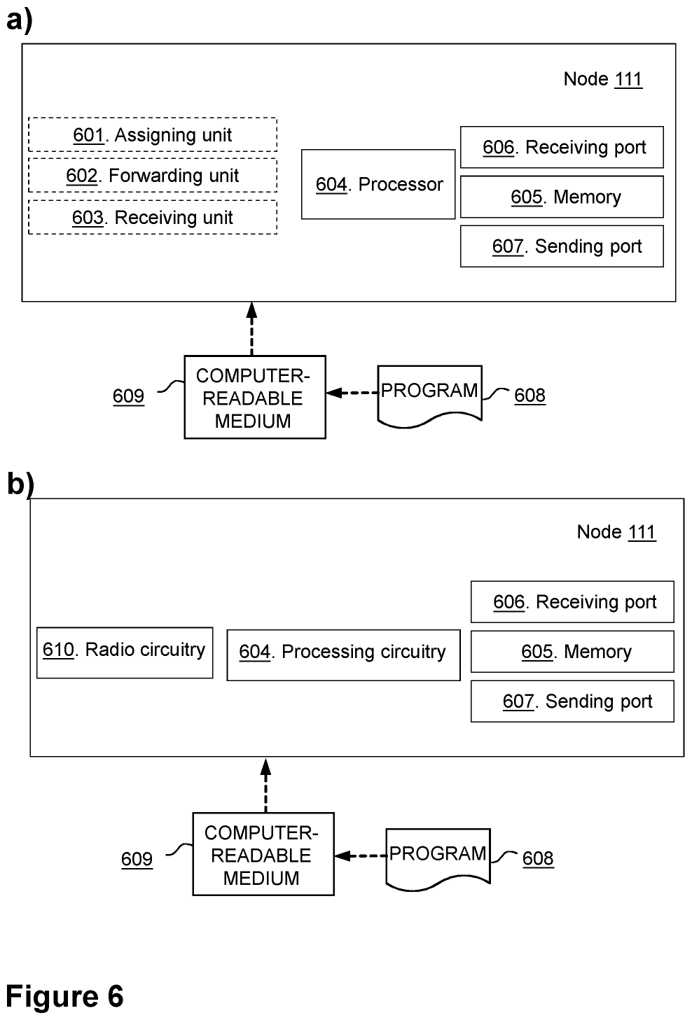

FIG. 6 depicts two different examples in panels a) and b), respectively, of the arrangement that the node 111 may comprise to perform the method actions described above in relation to FIG. 4. In some embodiments, the node 111 may comprise the following arrangement depicted in FIG. 6a. The node 111 is for handling the one or more member streams 121, 122, 123 configured to be split from the stream of frames. The node 111 is configured to support the at least one replication function 133 and the at least one elimination function 131 to process the one or more member streams 121, 122, 123. The node 111 is further configured to operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the node 111, and will thus not be repeated here. For example, the frames may be configured to comprise the plurality of packets.

In FIG. 6, optional units are indicated with dashed boxes.

The node 111 is configured to, e.g. by means of an assigning unit 601 within the node 111 configured to, assign the indication to the frame of the one or more frames configured to be comprised in the first member stream 121, of the one or more member streams 121, 122, 123, the first member stream 121 being configured to be output from the at least one elimination function 131. The indication is configured to be the same in every frame of the one or more frames. The indication is configured to identify the first member stream 121 as being an output member stream comprised in the stream of frames.

To assign the indication may be configured to be performed to every frame of the one or more frames configured to be comprised in the first member stream 121.

The indication may be further configured to uniquely identify the one or more frames configured to be comprised in the first member stream 121 from any frames configured to be comprised in the other one or more member streams 122, 123 of the node 111.

The first member stream 121 may be configured to comprise at least two frames configured to be originated in different ingress member streams or different member streams configured to be input into the at least one elimination function 131.

The node 111 is also configured to, e.g. by means of a forwarding unit 602 within the node 111 configured to, forward the first member stream 121 configured to egress from the at least one elimination function 131, as configured to be identified by the indication, to at least one of: a) the another function 132 supported by the node 111, and b) the another node 112 configured to operate in the communications network 100.

In some embodiments, to assign may be configured to comprise changing a parameter to handle the stream to the indication.

In some embodiments, the parameter may be configured to be a stream_handle parameter.

In some embodiments, to assign may be configured to be performed prior to a PRESENT_DATA event in a Sequence Recovery Function.

In some embodiments, to assign may be configured to be performed during an Individual Recovery Function.

In some embodiments, the indication may be configured to be a managed object.

In some embodiments, the indication may be configured to be frerSeqRcvyStreamOut.

The node 111 may be further configured to, e.g. by means of a receiving unit 603 within the node 111 configured to, receive, at the another function 132, the first member stream 121 configured to output from the at least one elimination function 131, as identified by the indication.

The node 111 may be configured to support multi-stage FRER.

In some embodiments, the communications network 100 may be configured to support Time Sensitive Networking (TSN).

The embodiments herein may be implemented through one or more processors, such as a processor 604 in the node 111 depicted in FIG. 6, together with computer program code for performing the functions and actions of the embodiments herein. The program code mentioned above may also be provided as a computer program product, for instance in the form of a data carrier carrying computer program code for performing the embodiments herein when being loaded into the in the node 111. One such carrier may be in the form of a CD ROM disc. It is however feasible with other data carriers such as a memory stick. The computer program code may furthermore be provided as pure program code on a server and downloaded to the node 111.

The node 111 may further comprise a memory 605 comprising one or more memory units. The memory 605 is arranged to be used to store obtained information, store data, configurations, schedulings, and applications etc. to perform the methods herein when being executed in the node 111.

In some embodiments, the node 111 may receive information from, e.g., other nodes in the communications network 100 and/or a source entity, through a receiving port 606. In some examples, the receiving port 606 may be, for example, connected to one or more antennas in node 111. In other embodiments, the node 111 may receive information from another structure in the communications network 100 through the receiving port 606. Since the receiving port 606 may be in communication with the processor 604, the receiving port 606 may then send the received information to the processor 604. The receiving port 606 may also be configured to receive other information.

The processor 604 in the node 111 may be further configured to transmit or send information to e.g., the another 112, and/or the destination entity, through a sending port 607, which may be in communication with the processor 604, and the memory 605.

Those skilled in the art will also appreciate that the units 601-603 described above may refer to a combination of analog and digital circuits, and/or one or more processors configured with software and/or firmware, e.g., stored in memory, that, when executed by the one or more processors such as the processor 604, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Those skilled in the art will also appreciate that any of the units 601-603 described above may be the processor 604 of the node 111, or an application running on such processor 604.

Thus, the methods according to the embodiments described herein for the node 111 may be respectively implemented by means of a computer program 608 product, comprising instructions, i.e., software code portions, which, when executed on at least one processor 604, cause the at least one processor 604 to carry out the actions described herein, as performed by the node 111. The computer program 608 product may be stored on a computer-readable storage medium 609. The computer-readable storage medium 609, having stored thereon the computer program 608, may comprise instructions which, when executed on at least one processor 604, cause the at least one processor 604 to carry out the actions described herein, as performed by the node 111. In some embodiments, the computer-readable storage medium 609 may be a non-transitory computer-readable storage medium, such as a CD ROM disc, a memory stick, or stored in the cloud space. In other embodiments, the computer program 608 product may be stored on a carrier containing the computer program, wherein the carrier is one of an electronic signal, optical signal, radio signal, or the computer-readable storage medium 609, as described above.

The node 111 may comprise an interface unit to facilitate communications between the node 111 and other nodes or devices, e.g., the node 111. In some particular examples, the interface may, for example, include a transceiver configured to transmit and receive radio signals over an air interface in accordance with a suitable standard.

In other embodiments, the node 111 may comprise the following arrangement depicted in FIG. 6b. The node 111 may comprise a processing circuitry 604, e.g., one or more processors such as the processor 604, in the node 111 and the memory 605. The node 111 may also comprise a radio circuitry 610, which may comprise e.g., the receiving port 606 and the sending port 607. The processing circuitry 604 may be configured to, or operable to, perform the method actions according to FIG. 4, in a similar manner as that described in relation to FIG. 6a. The radio circuitry 610 may be configured to set up and maintain at least a wireless connection with the node 111, the another node 112, the source entity, and/or the destination entity. Circuitry may be understood herein as a hardware component.

Hence, embodiments herein also relate to the node 111 operative to handle one or more member streams 121, 122, 123 configured to be split from a stream of frames. The frames may be operative to comprise the plurality of packets. The node 111 may be operative to support the at least one replication function 133 and the at least one elimination function 131 to process the one or more member streams 121, 122, 123. The node 111 may be further operative to operate in the communications network 100. The node 111 may comprise the processing circuitry 604 and the memory 605, said memory 605 containing instructions executable by said processing circuitry 604, whereby the node 111 is further operative to perform the actions described herein in relation to the node 111, e.g., in FIG. 4.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

A processor, as used herein, may be understood to be a hardware component.

1. A method performed by a node, the method being for handling one or more member streams split from a stream of frames, the node supporting at least one replication function and at least one elimination function to process the one or more member streams the node operating in a communications network, the method comprising:
assigning an indication to a frame of one or more frames comprised in a first member stream, of the one or more member streams, the first member stream outgoing from the at least one elimination function, the indication being the same in every frame of the one or more frames, the indication identifying the first member stream as being an output member stream comprised in the stream of frames; and
forwarding the first member stream outgoing from the at least one elimination function, comprising the one or more frames identified by the indication, to at least one of: a) another function supported by the node, and b) another node operating in the communications network.

2. The method according to claim 1, wherein the assigning of the indication is performed to every frame of the one or more frames comprised in the first member stream.

3. The method according to claim 1, wherein the indication uniquely identifies the one or more frames comprised in the first member stream from any frames comprised in the other one or more member streams of the node.

4. The method according to claim 1, wherein the first member stream comprises at least two frames originated in different ingress member streams or different member streams input into the at least one elimination function.

5. The method according to claim 1, wherein the assigning comprises changing a parameter to handle the stream to the indication, wherein the parameter is a stream_handle parameter.

6. (canceled)

7. The method according to claim 1, wherein assigning is performed one of: a) prior to a PRESENT_DATA event in a Sequence Recovery Function and b) during an Individual Recovery Function.

8. The method according to claim 1, wherein the indication is a managed object, wherein the indication is frerSeqRcvyStreamOut.

9. (canceled)

10. The method according to claim 1, further comprising:
receiving, at the another function, the first member stream output from the at least one elimination function, comprising the one or more frames as identified by the indication.

11. The method according to claim 1, wherein the node supports multi-stage Frame Replication and Elimination for Reliability, FRER.

12. The method according to claim 1, wherein the communications network supports Time Sensitive Networking, TSN.

13. (canceled)

14. (canceled)

15. A node, for handling one or more member streams configured to be split from a stream of frames, the node being configured to support at least one replication function and at least one elimination function to process the one or more member streams, the node being further configured to operate in a communications network, the node being further configured to:
assign an indication to a frame of one or more frames configured to be comprised in a first member stream, of the one or more member streams, the first member stream being configured to be output from the at least one elimination function, the indication being configured to be the same in every frame of the one or more frames, the indication being configured to identify the first member stream as being an output member stream comprised in the stream of frames; and
forward the first member stream configured to be output from the at least one elimination function, comprising the one or more frames as configured to be identified by the indication, to at least one of: a) another function supported by the node, and b) another node configured to operate in the communications network.

16. The node according to claim 15, wherein to assign the indication is configured to be performed to every frame of the one or more frames configured to be comprised in the first member stream.

17. The node according to claim 15, wherein the indication is configured to uniquely identify the one or more frames configured to be comprised in the first member stream from any frames configured to be comprised in the other one or more member streams of the node.

18. The node according to claim 15, wherein the first member stream is configured to comprise at least two frames configured to be originated in different ingress member streams or different member streams configured to be input into the at least one elimination function.

19. The node according to claim 15, wherein to assign is configured to comprise changing a parameter to handle the stream to the indication, wherein the parameter is configured to be a stream_handle parameter.

20. (canceled)

21. The node according to claim 15, wherein to assign is configured to be performed one of: a) prior to a PRESENT_DATA event in a Sequence Recovery Function and b) during an Individual Recovery Function.

22. The node according to claim 15, wherein the indication is configured to be a managed object, wherein the indication is configured to be frerSeqRcvyStreamOut.

23. (canceled)

24. The node according to claim 15, being further configured to:
receive, at the another function, the first member stream configured to output from the at least one elimination function, as identified by the indication.

25. The node according to claim 15, wherein the node is configured to support multi-stage Frame Replication and Elimination for Reliability, FRER.

26. The node according to claim 15, wherein the communications network is configured to support Time Sensitive Networking, TSN.
